(19) United States
(12) Patent Application Publication
(10) Pub. No.: US 2020/0126694 A1
(43) Pub. Date: Apr. 23, 2020

(54) ELECTRIC WIRE AND STATOR

(71) Applicant: HONDA MOTOR CO., LTD., Tokyo (JP)

(72) Inventors: Ryotaro Kaneko, Wako-shi (JP); Keisuke Azusawa, Wako-shi (JP); Tadao Nishiyama, Wako-shi (JP)

(21) Appl. No.: 16/597,957

(22) Filed: Oct. 10, 2019

(30) Foreign Application Priority Data
Oct. 18, 2018 (JP) 2018-196992

(51) Int. Cl. H01B 13/06; H01B 3/30; H01B 7/02; H01B 3/00

(52) U.S. Cl. CPC H01B 13/06; H01B 3/006; H01B 7/0208; H01B 3/30

(57) ABSTRACT

An electric wire includes a conductor, and an insulating film that is configured to cover the conductor and that includes a porous layer having a porous therein, and a non-porous layer in which no porous is formed, wherein the non-porous layer is disposed as an outermost layer of the insulating film.

### CROSS-REFERENCE TO RELATED APPLICATION

Priority is claimed on Japanese Patent Application No. 2018-196992, filed Oct. 18, 2018, the content of which is incorporated herein by reference.

### BACKGROUND OF THE INVENTION

### Field of the Invention

The present invention relates to an electric wire and a stator.

### Description of Related Art

In the related art, as a stator for a rotating electric machine, a configuration including a coil mounted on a stator core by inserting a conductor segment into slots formed in the stator core and welding conductor end portions protruding from the stator core is known. Since a high voltage is applied to such a coil, technologies of increasing electrical resistance characteristics of an insulating film in an electric wire have been variously proposed.

For example, PCT International Publication No. 2017/073551 discloses a structure of an electric wire having a plurality of pores (porous) in an insulating film. According to the technology disclosed in PCT International Publication No. 2017/073551, the insulating film having a low dielectric constant can be realized by a formation of the porous, and insulating characteristics of the electric wire with respect to a high voltage can be improved.

### SUMMARY OF THE INVENTION

However, in the technology disclosed in PCT International Publication No. 2017/073551, since the porous are also formed in the outermost layer of the insulating film, cracks may easily occur in the insulating film with the porous as the origin when the electric wire is bent. Accordingly, there is a room for improvement in terms of providing an electric wire having an insulating film in which insulating characteristics are improved, occurrence of cracks with respect to bending is suppressed, and flexibility is excellent, and a stator using such electric wire.

An aspect of the present invention is directed to providing an electric wire having an insulating film in which insulating characteristics are improved, occurrence of cracks with respect to bending is suppressed, and flexibility is excellent, and a stator using such electric wire.

(1) An electric wire according to an aspect of the present invention includes a conductor; and an insulating film that is configured to cover the conductor and that includes a porous layer having a porous therein, and a non-porous layer in which no porous is formed, wherein the non-porous layer is disposed as an outermost layer of the insulating film.

(2) In the aspect of the above-mentioned (1), a total thickness of the porous layer may be greater than a total thickness of the non-porous layer.

(3) In the aspect of the above-mentioned (2), only one non-porous layer may be disposed as the outermost layer of the insulating film.

(4) A stator according to an aspect of the present invention includes the electric wire according to any one of the above-mentioned (1) to (3).

According to the aspect of the above-mentioned (1), since the insulating film has the porous layer, the dielectric constant of the insulating film can be decreased by forming the porous, and the insulating properties of the electric wire with respect to a high voltage can be improved. In addition, since the non-porous layer, which has a smooth surface in which porous that can be an origin of cracks are not formed, is disposed as the outermost layer of the insulating film, occurrence of the cracks with respect to the bending can be suppressed. Further, even when the density of the porous in the porous layer is increased, since occurrence of the cracks in the outermost layer can be suppressed, flexibility can be improved while securing highly insulating characteristics.

Accordingly, it is possible to provide an electric wire having an insulating film in which insulating properties are improved, occurrence of the cracks with respect to the bending is suppressed, and flexibility is excellent.

According to the aspect of the above-mentioned (2), since the total thickness of the porous layer is greater than the total thickness of the non-porous layer, the insulating properties can be improved while maintaining flexibility. Accordingly, it is possible to provide an excellent electric wire in which a balance between the flexibility and the insulating properties are achieved.

According to the aspect of the above-mentioned (3), since only one non-porous layer is disposed as the outermost layer of the insulating film, in comparison with the case in which a plurality of non-porous layers are formed therein, a proportion of the porous layer having a low dielectric constant is increased. Accordingly, flexibility of the insulating film of only the outermost layer in which the cracks easily occur can be improved while enabling further improvement of the insulating properties of the insulating film. Accordingly, it is possible to provide the electric wire in which efficiency in improvement of the insulating properties is increased.

According to the aspect of the above-mentioned (4), it is possible to provide a high performance stator including the electric wire having an insulating film in which insulating properties are improved, occurrence of the cracks with respect to the bending is suppressed, and flexibility is excellent.

### BRIEF DESCRIPTION OF THE DRAWINGS

FIG. 1 is a perspective view of the appearance of a stator according to a first embodiment.

FIG. 2 is a cross-sectional view of an electric wire according to the first embodiment.

FIG. 3 is an enlarged view of a portion III in FIG. 2.

### DETAILED DESCRIPTION OF THE INVENTION

Hereinafter, an embodiment of the present invention will be described with reference to the accompanying drawings.

### (Stator)

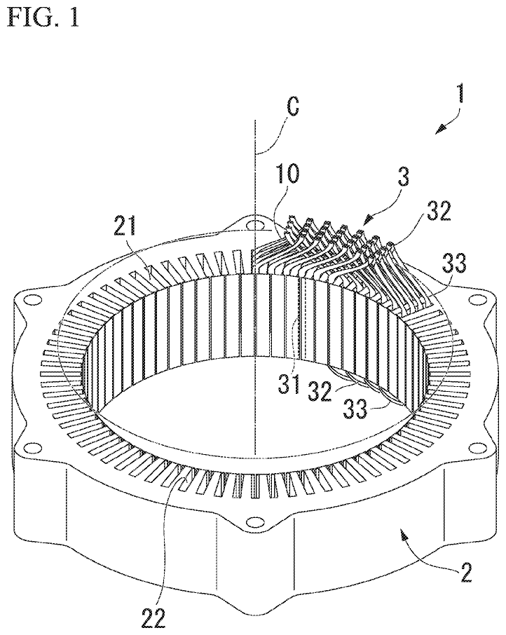

FIG. 1 is a perspective view of an appearance of a stator 1. The stator 1 includes a stator core 2 and a coil 3. Further, in FIG. 1, a part of the coil 3 is omitted for convenience of description.

The stator core 2 is formed in an annular shape about an axis C. Teeth 21 are formed in an inner circumferential surface of the stator core 2. The teeth 21 protrude inward from the inner circumferential surface of the stator core 2 in the radial direction. A plurality of teeth 21 are provided in a circumferential direction.

Slots 22 are formed between the teeth 21, and the coil 3, which will be described below, is inserted into the slots 22. A rotor (not shown) is rotatably disposed about the axis C in the stator core 2.

In the following description, a direction along the axis C of the stator core 2 may be referred to as an axial direction, a direction perpendicular to the axis C may be referred to as a radial direction, and a direction around the axis C may be referred to as a circumferential direction.

The coil 3 is inserted into the slots 22 of the stator core 2 and mounted on the stator core 2. The coil 3 is constituted by a plurality of electric wires 10. Specifically, the coil 3 is inserted into the slots 22 from one side in the axial direction (a side below in FIG. 1) in a state in which the plurality of electric wires 10 curved in a U shape are overlapped in the radial direction and the circumferential direction. After that, tip portions of the electric wires 10 protruding from the slots 22 toward the other side in the axial direction (a side above in FIG. 1) are joined to each other, and the coil 3 is mounted on the stator core 2. A portion of the coil 3 inserted into the slots 22 is a coil insertion section 31, and portions protruding from one side and the other side in the axial direction from an end surface of the stator core 2 are coil ends 32.

The coil 3 has bent sections 33 mainly provided on the coil ends 32 in which the electric wires 10 are curved in a predetermined direction. The bent section 33 is, for example, a curved section formed in a U shape or a twisted bent section when the tip portion protruding toward the other side in the axial direction is twisted and bent in the circumferential direction.

### (Electric Wire)

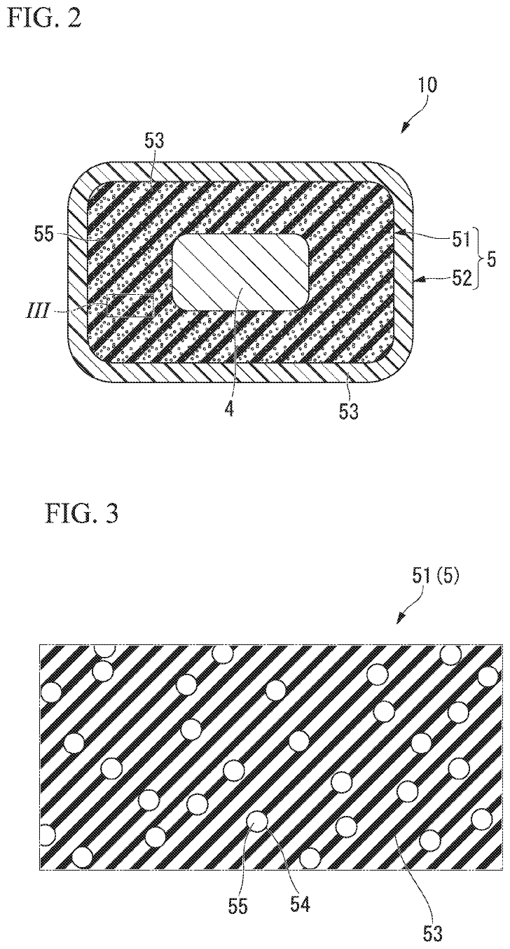

FIG. 2 is a cross-sectional view of the electric wire 10. FIG. 3 is an enlarged view of a portion III in FIG. 2. The electric wire 10 has a conductor 4 and an insulating film 5.

The conductor 4 constitutes a core portion of the coil 3, and for example, is formed of a metal material such as copper or the like.

The conductor 4 is formed in a linear shape having a rectangular cross section. In the coil end 32 disposed at the other side of the stator core 2 in the axial direction, parts of the conductors 4 are exposed, and the neighboring conductors 4 are electrically and physically joined to each other (see FIG. 1).

The insulating film 5 covers an outer circumferential section of the conductor 4. The insulating film 5 is formed of, for example, an insulating resin. The insulating film 5 is formed throughout the length of the conductor 4 other than on an exposed portion of the conductor 4 in the coil end 32 disposed at the other side in the axial direction. The insulating film 5 has a porous layer 51 and a non-porous layer 52.

The porous layer 51 has a film main body 53 and capsules 54 (see FIG. 3).

The film main body 53 is formed of, for example, an insulating resin such as a polyimide or the like. As shown in FIG. 3, the film main body 53 has a plurality of hollow capsules 54 therein.

The capsules 54 are formed of a resin different from that of the film main body 53. The capsules 54 are formed of a resin such as silicone resin or the like. The capsules 54 are formed in a spherical shape. The inside of the capsule 54 is a porous 55. In other words, the porous layer 51 has the porous 55 therein. The capsules 54 and the porous 55 are formed in the insulating film 5 as a core shell type pyrolytic resin, in which an outer shell thereof is surrounded by an outer shell member (becomes the capsules 54 later on), is heated and the pyrolytic resin is gasified.

Returning to FIG. 2, the non-porous layer 52 is disposed as the outermost layer of the insulating film 5. The non-porous layer 52 has the film main body 53 formed with no porous 55 therein. Here, forming the body with no porous 55 indicates a state in which the porous 55 is not created by including the pyrolytic resin but not being heated, a state in which the porous 55 is not provided because the pyrolytic resin is inherently not contained therein, or the like. A total thickness of the non-porous layer 52 is smaller than a total thickness of the porous layer 51. In the embodiment, only one non-porous layer 52 is disposed as the outermost layer of the insulating film 5. That is, a thickness of the non-porous layer 52 disposed as the outermost layer is smaller than a thickness of the porous layer 51. Further, a total thickness of the porous layer 51 indicates a value obtained by summing thicknesses of all the porous layers 51 in the radial direction provided in the insulating film 5. That is, when the insulating film 5 has a plurality of porous layers 51, the value indicates a value obtained by summing thicknesses of the porous layers 51. Similarly, a total thickness of the non-porous layer 52 indicates a value obtained by summing thicknesses in the radial direction of all non-porous layers 52 provided in the insulating film 5.

Here, provided that a dielectric constant of the film main body 53 is a, a dielectric constant of the insulating film 5 (the porous layer 51) having the porous 55 therein is β, and a dielectric constant of air (the porous 55) is γ, α>β>γ. Accordingly, the dielectric constant 13 of the porous layer 51 having the porous 55 therein is smaller than the dielectric constant α of the non-porous layer 52 with no porous 55 therein, and an electricity resistance property of the entire the insulating film 5 is improved by providing the porous layer 51.

### Actions and Effects

Next, actions and effects of the electric wires 10 and the stator 1 will be described.

Here, in the configuration in the related art in which the insulating film 5 has only the porous layer 51, the capsules 54 are also formed in the outermost layer of the insulating film 5. For this reason, in the bent sections 33 in which the electric wires 10 are curved in the predetermined direction, cracks easily occur in the insulating film 5 from portions in which the film main body 53 is damaged due to formation of the capsules 54 as the origin. Accordingly, it was necessary to devise reduction in the density of the contained porous 55, or the like, and it was difficult to achieve both of high insulating properties and flexibility in the related art.

According to the electric wire 10 of the configuration, since the insulating film 5 has the porous layer 51, the dielectric constant of the insulating film 5 is decreased by the formation of the porous 55, and insulating properties of the electric wires 10 with respect to a high voltage can be improved. Meanwhile, since the non-porous layer 52, which have a smooth surface on which the porous 55 that can be the origin of the cracks is not formed, is disposed as the outermost layer of the insulating film 5, occurrence of the cracks with respect to the bending can be suppressed. Further, even when the density of the porous 55 in the porous layer 51 is increased, since occurrence of cracks in the outermost layer of the insulating film 5 can be suppressed, and flexibility of the insulating film 5 can be improved while securing high insulating properties.

Accordingly, it is possible to provide the electric wire 10 having the insulating film 5 in which insulating properties are improved, occurrence of cracks with respect to the bending is suppressed, and flexibility is excellent.

In addition, since the thickness of the porous layer 51 is greater than the thickness of the non-porous layer 52, the insulating properties can be further improved while maintaining flexibility. Accordingly, it is possible to provide the excellent electric wire 10 in which a balance between the flexibility and the insulating properties are achieved.

In the embodiment, since only one non-porous layer 52 is disposed as the outermost layer of the insulating film 5, in comparison with the case in which a plurality of non-porous layers are disposed therein, a proportion of a porous layer having a low dielectric constant is increased. Accordingly, flexibility of only the insulating film 5 of the outermost layer in which cracks easily occur can be improved while enabling further improvement of the insulating properties of the insulating film 5. Accordingly, it is possible to provide the electric wire 10 in which efficiency in improvement of the insulating properties is increased.

According to the stator 1 of the configuration, it is possible to provide the high performance stator 1 including the electric wire 10 in which insulating properties are improved, occurrence of cracks with respect to the bending is suppressed, and flexibility is excellent.

Further, the technical scope of the present invention is not limited to the above-mentioned embodiment, and various modifications may be made without departing from the scope of the present invention.

For example, in the embodiment, while the configuration in which the insulating film 5 has the porous layer 51 and the non-porous layer 52, each of which is a single layer, has been described, there is no limitation thereto. That is, a plurality of layers, in which the porous layers 51 and the non-porous layers 52 are alternately formed, may be formed as long as the non-porous layer 52 is disposed as the outermost layer of the insulating film 5.

In addition, a cross-sectional shape of the conductor 4 and the insulating film 5 may be, for example, a circular shape or the like.

A material of the film main body 53 may be an insulating resin other than polyimide.

In the embodiment, while the configuration in which the porous 55 is surrounded by the capsule 54 has been described, the capsule 54 may not be provided. That is, the porous 55 may be directly formed in the insulating film 5.

While preferred embodiments of the invention have been described and illustrated above, it should be understood that these are exemplary of the invention and are not to be considered as limiting. Additions, omissions, substitutions, and other modifications can be made without departing from the scope of the present invention. Accordingly, the invention is not to be considered as being limited by the foregoing description, and is only limited by the scope of the appended claims.

What is claimed is:

1. An electric wire comprising:
a conductor; and
an insulating film that is configured to cover the conductor and that includes a porous layer having a porous therein, and a non-porous layer in which no porous is formed,
wherein the non-porous layer is disposed as an outermost layer of the insulating film.

2. The electric wire according to claim 1, wherein a total thickness of the porous layer is greater than a total thickness of the non-porous layer.

3. The electric wire according to claim 2, wherein only one non-porous layer is disposed as the outermost layer of the insulating film.

4. A stator comprising the electric wire according to claim 1.
